(19) United States
(12) Patent Application Publication
(10) Pub. No.: US 2017/0087923 A1
(43) Pub. Date: Mar. 30, 2017

(54) METHOD AND APPARATUS FOR EXTENDING AND RETRACTING THE WRITING ELEMENT OF A SELF-RETAINING WRITING INSTRUMENT

(71) Applicant: James Michael Elmore, Atlanta, GA (US)

(72) Inventor: James Michael Elmore, Atlanta, GA (US)

(21) Appl. No.: 14/868,401

(22) Filed: Sep. 29, 2015

(51) Int. Cl. B43K 24/02; B43K 7/12; B43K 8/24; B43K 19/00

(52) U.S. Cl. CPC B43K 24/023; B43K 19/006; B43K 7/12; B43K 8/24

(57) ABSTRACT

The method and apparatus described herein allows for the automatic retraction and extension of the writing element of a bistable self-retaining writing instrument. The method and apparatus consists of a writing element that is joined to the end of a flexible tube or material. These are inserted through a longitudinal channel formed along the outer surface of the writing instrument and are anchored only at the end opposite the writing element. When the bistable self-retaining writing instrument transitions from a coiled to straight configuration the writing element is automatically exposed. Conversely, when pushed into its coiled configuration the writing element slides back into the channel and is thereby protected. The flexible tube or material may also act as a reservoir for a writing substrate such as ink.

### CROSS-REFERENCE TO RELATED APPLICATIONS

The present application claims priority benefit of U.S. Provisional Application No. 62/056,737 filed Sep. 29, 2014, which is incorporated herein by reference. In addition this application is related to U.S. patent application Ser. No. 13/856,914 filed Apr. 4, 2013 now U.S. Pat. No. 9,061,541 B2 (Self-retaining writing instrument) issued Jun. 23, 2015.

### FIELD

The present disclosure relates generally to writing instruments, specifically to a method and apparatus for extending and retracting the writing element of a self-retaining writing instrument.

### BACKGROUND OF THE INVENTION

Writing instruments, such as pens, pencils, and styluses, are used by millions of people every day. Most writing instruments have methods for protecting the writing element in order to prevent users from unintentionally writing with them. For example, some writing instruments have caps, which are one of the simplest of current techniques. Caps fit over the ends of writing instruments to protect and cover the writing element in order prevent unintentional use and/or leaking. Other methods include spring and/or slide assisted mechanisms, which allow retraction of the writing element within the writing instrument, such as with “clicker” pens.

Current techniques to protect the writing element of writing devices are not sufficient in many instances. Caps may be cumbersome (i.e. require two hands, one to hold the pen and the other to remove the cap), may be easy to lose, and may fall off inadvertently. Spring and/or slide-assisted mechanisms may be bulky, require additional parts, be expensive, and/or interfere with the use and function of the writing instrument.

Recently, a self-retaining writing instrument was invented which includes two principal components—a bi-stable spring and a writing element. In the straight configuration, the self-retaining writing instrument is stable enough that it can be used as a typical writing utensil. Secondary to its bistable nature, this writing instrument assumes a coiled configuration when stressed appropriately allowing it to be stored around something, usually, but not exclusively, the user's wrist.

An important feature of the bistable writing instrument is that the writing element needs to be exposed for writing and protected when worn or otherwise not being used. Unfortunately, caps frequently do not stay in place, and spring and/or slide-assisted mechanisms are bulky and not ideal for use with the bistable writing instrument as these may be more costly and, more importantly, interfere with adequate coiling or function of the bistable writing instrument.

Typical writing pens exist only in one configuration and, in general, contain ink cartridges that store writing material in a reservoir that is in fluid communication with the writing tip (i.e. ballpoint). Currently available ink cartridges are also not adequate for use with a self-retaining bistable writing instrument secondary to their inherent rigidity that impedes the ability of the self-retaining bistable writing instrument from assuming its coiled configuration.

Accordingly, there remains a considerable need for an improved method and apparatus for protecting the writing element of a writing device, specifically as relates to the self-retaining bistable writing instrument.

### SUMMARY

In one aspect, the method and apparatus for extending the writing element of a bistable writing instrument is provided which occurs automatically with the change in configuration of the bistable writing instrument from its coiled to straight configuration. In certain embodiments, the method and apparatus for extending the writing element of a bistable writing instrument includes a flexible tube or material that is anchored to one end or position of the writing instrument and contains an element to be extended and retracted on the opposite end. The element to be extended/retracted is typically, but not limited to a writing element. In certain embodiments, the element to be extended is a pen tip, pencil tip, stylus, or marker.

In another aspect, the method and apparatus for retracting the writing element includes a flexible tube containing ink or other marking material (i.e. ink cartridge) that is sufficiently flexible as to not interfere with the coiling of the bistable writing instrument yet non-compressible enough that, when supported within a plastic or silicone cover or channel of the writing instrument, will accommodate the stress needed for writing.

In another aspect, the method and apparatus for extending/retracting the writing element of the self-retracting bistable writing instrument utilizes the change in length that occurs on the outer side of the bistable spring as it transitions between its coiled and straight configurations. Therefore, as the bistable writing instrument is uncoiled and straightened, the writing element extends automatically. The writing element extends as a result of the increase in length along the outer aspect of the bistable writing instrument, relative to its inner aspect. In this manner, the flexible tube or material, which is anchored only at one end, is allowed to slide forward, through a channel running longitudinally along the top of the outer aspect of the bistable writing instrument, thereby allowing its extension when straightened and retraction when coiled.

In another aspect, the method and apparatus for extending the writing element of the bistable writing instrument includes a flexible material that is anchored at one end or position and courses longitudinally along the outer aspect of the bistable writing instrument. This material is flexible enough as to not interfere with the coiling and straightening of the bistable writing instrument yet has adequate compressive and tensile strength that, when supported by the cover of the bistable writing instrument, may act to appropriately extend and retract an element that may include, but is not limited to, one containing ink, one containing a material that may be useful for writing on capacitive or resistive touch screens (i.e. tablet stylus), or one containing pencil lead.

### BRIEF DESCRIPTION OF THE DRAWING

FIG. 1 is a top view of a bi-stable spring usable for forming a self-retaining bistable writing instrument (SRWI).

FIG. 2 is a side view of the bi-stable spring of FIG. 1.

FIG. 3 is an exploded view of a writing element and a flexible, less-compressible tubing or material.

FIG. 4 is an assembled view of the writing element of FIG. 3 attached to the end of the flexible, less/non-compressible tubing/material.

FIG. 5 is a top view of the automatically retracting self-retaining bistable writing device, in its straight configuration. Note that the top of the channel running the length of the writing instrument is cut away to show the flexible tube/material and that, in the straight configuration, the writing element extends beyond the end of the instrument and therefore is adequately exposed for writing.

FIG. 6 is a side view of the automatically retracting self-retaining bistable writing device of FIG. 5.

FIG. 7 is a side view of the automatically retracting self-retaining bistable writing device (SRWI) of FIG. 6 in a coiled configuration. Note that the writing element is retracted within the covering and therefore protected.

FIG. 8 is the exploded view of the automatically retracting self-retaining bistable writing device showing the principal components. Note the notch in the sheet metal base that is one method that may be used to anchor the pen tube or material at the end position of the instrument.

FIG. 9 is the end-on and perspective views of the automatically retracting self-retaining bistable writing device.

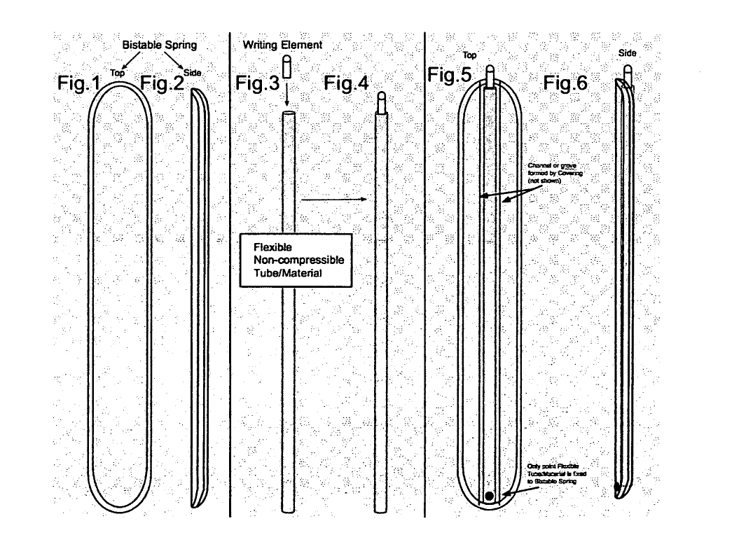

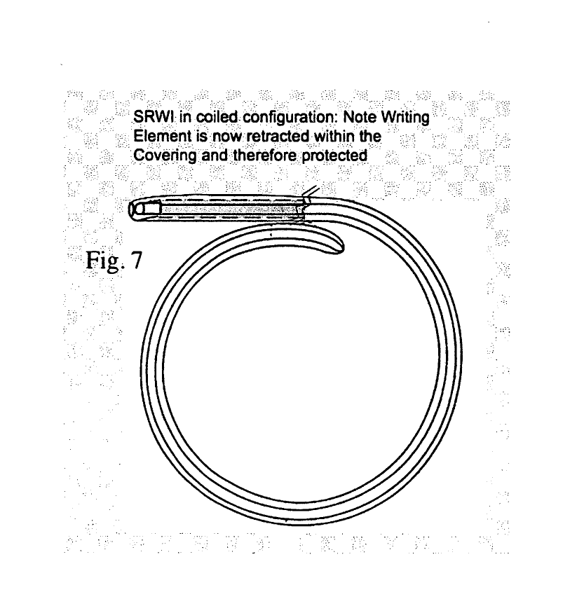

### DETAILED DESCRIPTION OF THE INVENTION

The present disclosure will now be described more fully hereinafter with reference to the accompanying drawings, like numbers refer to like elements throughout the drawings.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Several embodiments of the method and apparatus for retracting the writing element of a self-retaining writing instrument are possible and may also be used with other materials or designs that would be obvious to those skilled in the art.

Broadly, an embodiment of the present invention provides a method for retracting and extending the writing element of a self-retaining bistable writing instrument. Retraction and extension of the writing element, as detailed and described, occurs automatically as the bi-stable spring of the writing instrument is coiled and uncoiled or straightened. The apparatus and method of the present invention obviates the need for caps or covers, as well as the need for alternative mechanisms to extend and retract the writing element.

The automatically retracting and extending apparatus of the bistable writing instrument of the present invention includes four principal components: (1) a bi-stable spring (FIGS. 1 and 2), (2) a writing element (FIG. 2), (3) a flexible but less-compressible material or tube (FIG. 4) and (4) a cover of appropriate material, which acts to hold the other parts together and which may wholly or partly contain a channel/tunnel/or groove running longitudinally down the outer surface of the bistable writing instrument which supports, without binding, the writing element (2) attached to the flexible tuber or material (3).

The bi-stable spring is typically made of, but not limited to, a metal or plastic that is fashioned in such a way as to be stable in both the coiled and straight configurations. When the bi-stable spring is stressed sufficiently while in its straight configuration, it changes shapes into a circular coil.

The flexible and non-compressible material or tube may wholly or partly act as a substrate reservoir and thereby provide, by fluid communication, a substrate (typically but not limited to ink), if needed, to the writing element. The flexible and less/non-compressible material is flexible enough to conform, with minimal resistance, to both the straight and coiled configuration of the bi-stable spring; yet non-compressible enough that, with support from the covering, will remain sufficiently stable for the length-wise compressive pressures applied to it from writing.

The writing element may include, but is not limited to, a ball point pen tip, stylus, felt marker, or pencil type lead. The covering may be of any suitable material that is both sufficiently strong but also adequately flexible, typically silicone, vinyl, or fabric.

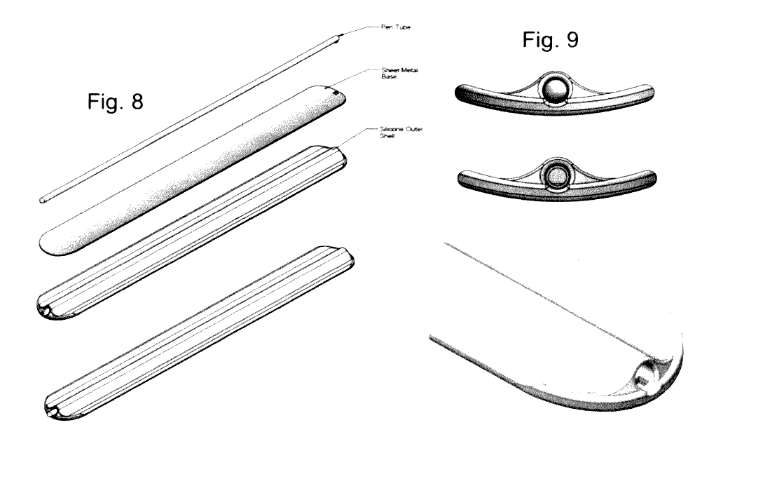

The writing element and the flexible less/non-compressible material or tube are attached or joined to one another. These may be joined by glue, heat-shrinking, or similar technique. Together these lie longitudinally on and in the mid aspect of the outer surface of the bi-stable spring in a groove or channel formed by the covering. The flexible less/non-compressible material or tube is fixed to the bi-stable spring and/or covering only at the end opposite, or otherwise sufficiently distant from, the writing element. In this manner the covering is allowed to slide over the flexible material and the writing element as the bistable spring is straightened from its coiled configuration. The flexible tube or material may be fixed to the appropriate end or position of the bistable writing instrument using any number of methods or combination of methods including, but not limited to a notch mechanism (FIG. 8), clip mechanism, glue, or heat shrinking.

When the bistable writing instrument is straight, the writing element is extended and protrudes from the cover sufficiently to allow for use (i.e. writing). When the bistable writing instrument is stressed appropriately and assumes a coiled configuration, the outer surface of the bi-stable spring, upon which lies the writing element and flexible non-compressible material or tube, lengthens relative to the inner surface. Since the flexible but non-compressible material is fixed to the bi-stable spring only at one end, the increase in length of the outer surface of the writing instrument relative to its inner surface allows the covering to slide forward over the writing element thereby protecting it from unintentional use.

The method and apparatus for extending the writing element of the self-retaining bistable writing instrument may be made using various techniques and materials. The self-retaining bistable writing instrument is currently being manufactured using existing techniques consisting of a bi-stable spring, a writing element, and a silicone cover. In order to employ the concepts of the current invention, a flexible but less/non-compressible tube or material, which may act as a reservoir for a writing substrate, could be fashioned from existing materials and joined, using existing techniques, to the writing element. The writing element and flexible tube or material would then be inserted through a channel formed longitudinally along the outer aspect of the cover of the self-retaining writing instrument and secured only at the end opposite the writing element.

The writing element and flexible tube or material may be fixed to the appropriate end or position of the writing instrument using any number of methods such as an anchor, peg and hole, notch, clip, or glue. The flexible tube or material would be made flexible enough as to not interfere with the coiling of the bistable writing instrument yet would be, when supported within the channel formed by the cover, sturdy enough to permit writing. Any number of materials may suffice for this including, but not limited to, any number of plastic or plastic-like materials. Typical and currently available ink cartridges do not suffice for this purpose as they to not possess the requisite dimensions and flexibility for use within a self-retaining writing instrument.

The non-compressible material or tube could then be wielded, glued, clipped, snapped or otherwise fixed onto only one end or adequately distant position of the writing instrument. The bi-stable spring, writing element, and non-compressible material or tube is then covered with a material including, but not limited to, silicone, which is molded or formed to provide a channel running longitudinally along the outer aspect of the writing element. In this fashion the writing element, joined to the less/non-compressible material or tube (i.e. ink cartridge), is supported, but not bound, within the channel or groove oriented longitudinally along the mid and outer aspect of the bistable writing instrument. In this fashion, the writing element joined to the flexible non-compressible tube or material, is permitted to slide freely within it and along the bi-stable spring in order to allow extension and retraction of the writing element.

It should be understood, of course, that the foregoing relates to exemplary embodiments of the invention and that modifications may be made without departing from the spirit and scope of the invention as set forth in the following claims.

What is claimed is:

1. The method and apparatus for retracting and extending the writing element of a self-retaining writing instrument as herein shown and described comprising:
a flexible tube or material that is joined to an element to be extended and retracted on one end and is anchored at an adequately distant position on the opposite end, and lying within a channel formed by the cover of a self-retaining writing instrument.

2. The method and apparatus for retracting and extending the writing element of a self-retaining writing instrument in claim 1, wherein the writing element extends and retracts automatically with the configuration change of the bistable self-retaining writing instrument.

3. The method and apparatus for retracting and extending the writing element of a self-retracting writing instrument in claim 1, wherein the writing element consists of a pen, stylus, marker, or pencil lead.

4. The method and apparatus for retracting and extending the writing element of a self-retracting writing instrument in claim 1, wherein the flexible tube or material acts as a reservoir for a writing substrate such as ink.
